(19) United States
(12) Patent Application Publication
(10) Pub. No.: US 2007/0199247 A1
(43) Pub. Date: Aug. 30, 2007

(54) Weather strip for motor vehicle

(75) Inventors: Kisato Oba, Aichi-ken (JP); Masahiro Nozaki, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 11/709,189

(22) Filed: Feb. 22, 2007

(30) Foreign Application Priority Data
Feb. 28, 2006 (JP) 2006-051850

(51) Int. Cl. E06B 7/22

(52) U.S. Cl. 49/498.1

(57) ABSTRACT

A weather strip for a motor vehicle, which is capable of being elongated or contracted upon the attachment to a vehicle body, thereby facilitating the attachment thereof. The weather strip has a ring-shaped configuration by connecting longitudinal ends thereof to each other with a connecting section, and includes a base portion for attachment to a flange provided in a closing member for closing an opening in a vehicle body or an opening portion around the opening, and a seal portion integrally formed with the base portion for contacting a facing member, that is the opening portion or the closing member and sealing a gap therebetween. The base portion includes at least a bottom wall and an outer side wall and has a generally L-shaped cross-section. A double-sided adhesive tape is bonded to an interior face of the outer side wall except for a predetermined area which ranges between both longitudinal ends of the connecting section.

### CROSS-REFERENCE TO RELATED APPLICATION

This application is related to and claims priority from Japanese patent application No. 2006-051850, incorporated herein by reference.

### BACKGROUND OF THE INVENTION

1. Field of the Invention

The present invention relates to a weather strip for providing a seal between an opening portion of a vehicle body and a closing member for closing the opening portion, such as a vehicle door, a trunk lid, a sliding roof, etc.

2. Description of Related Art

Hereinafter, the present invention will be explained with reference to an opening trim weather strip 10 for sealing a gap between a vehicle door 12 and a door opening portion 14, as shown in FIG. 1.

FIG. 2 is a cross-sectional view of one example of a conventional opening trim weather strip which is attached to a door opening portion of a motor vehicle. As shown, in order to provide a seal between the vehicle door 12 and the door opening portion 14, a door weather strip 16 is attached to a retainer 18 provided along an outer periphery of a door frame, etc. of the door 12, a glass run 20 is attached to a channel 22 provided along an inner periphery of the door frame, etc., and an opening trim weather strip 24 is attached to a flange 26 projecting from the door opening portion 14. The flange 26 is formed by an outer body panel 28 and an inner body panel 30, which define the door opening portion 14 of the vehicle body.

The glass run 20 includes an outer side wall 32, a bottom wall 34 and an inner side wall 36, and has a generally U-shaped cross-section. When a door glass 38 is raised, an end of the door glass 38 enters the glass run 20, and is sealed with an outer seal lip 40 and an inner seal lip 42.

The door weather strip 16 attached to the outer periphery of the door 12 includes a base portion 44, a tubular seal portion 46 integrally formed on the base portion 44, and a seal lip 48. The base portion 44 is secured to the door frame by fitting the base portion 44 in the retainer 18 provided along the outer periphery of the door frame. When the door 12 is closed, the seal lip 48 contacts an outer end of the door opening portion 14 and the tubular seal portion 46 contacts a protruding part of the door opening portion 14 on the inner side of the contacting position of the seal lip 48 to provide a double seal between the door opening portion 14 and the vehicle door 12.

The opening trim weather strip 24 attached to the flange 26 provides a seal between the door opening portion 14 and the vehicle door 12 on the inner side of the contacting position of the tubular seal portion 46 of the door weather strip 16. The opening trim weather strip 24 includes a base portion 50 having a U-shaped cross-section and a tubular seal portion 52. The base portion 50 is attached to the flange 26 and the tubular seal portion 52 contacts a protruding part 54 of the door frame to provide a seal between the door opening portion 14 and the vehicle door 12. An insert member 56 such as a metal insert, etc. is embedded in the base portion 50, and lips are provided in the base portion 50 for holding the flange 26.

This opening trim weather strip 24 is attached over the entire circumference of the door opening portion 14. As shown in FIG. 2, in an upper part of the door opening portion 14, the base portion 50 is fitted unto the flange 26 from the lower side thereof. In contrast, as shown in FIG. 3, in a lower part of the door opening portion 14, the base portion 50 is fitted unto the flange 26 from the upper side thereof, and a scuff plate 58 is attached for protecting the base portion 50.

However, the weight of this opening trim weather strip 24 increases due to the metal insert 56 embedded therein, and a force is required to insert the flange 26 in the base portion 50, and consequently, the attaching work is troublesome, thereby lowering the work efficiency.

The thickness of the flange 26 provided in the door opening portion 14 varies locally. The flange 26 is formed by joining ends of body panels defining the vehicle body. The number of such panels to be joined ranges from two through about five pieces, and the thickness of the flange 26 ranges from about 2 through about 8 mm.

Therefore, where the opening trim weather strip 24 is attached over the entire circumference of the door opening portion 14 with the U-shaped base portion 50 in which the metal insert 56 is embedded, the inserting force of the flange 26 may increase or the holding force against the flange 26 may decrease according to the positions in the door opening portion 14. In order to overcome these problems, the configuration of the holding lips provided inside the base portion 50 has been variously arranged, but sufficient solutions have not been obtained.

In order to overcome the above-described problems and increase the flexibility of the base portion, in the conventional arrangement shown in FIG. 4, no insert member such as a metal insert is embedded in a base portion 60 of an opening trim weather strip 62, and the base portion 60 is attached to the flange 26 with a double-sided adhesive tape 64 (See Japanese patent No. 3180493 and Publication of unexamined Japanese patent application No. 2001-151035, ex.). In this case, the double-sided adhesive tape 64 is previously bonded to an interior face of an outer side wall of the base portion 60, and the flange 26 is inserted in the base portion 60 to bring the double-sided adhesive tape 64 into pressure contact with an exterior face of the flange 26.

And in order to readily attach the opening trim weather strip 62 to the flange 26, an inner side wall of the base portion 60 is made short, whereas the double-sided adhesive tape 64 is bonded to the longer outer side wall thereof. Then, an end of the flange 26 is inserted in the base portion 60 to the bottom thereof, and the base portion 60 is turned in the direction shown by the arrow to bond the double-sided adhesive tape 64 to the exterior face of the flange 26.

Where the insert member is not embedded, however, the elasticity of the opening trim weather strip 62 increases in a longitudinal direction thereof. Accordingly, when the opening trim weather strip 62 is attached to the flange 26, the opening trim weather strip 62 is gradually elongated, and at last, may come off the flange 26, or form folds therein.

In addition, when the opening trim weather strip 62 is bonded to the flange 26 with the double-sided adhesive tape 64, after removing a protective tape therefrom, the flange 26 is inserted in the base portion 60 to bring the double-sided adhesive tape 64 into pressure contact with the exterior face of the flange 26. At this time, where elongating force and contracting force generated upon the attaching operation of the opening trim weather strip 62 remain therein, after attachment, the opening trim weather strip 62 is contracted gradually to apply a force to the double-sided adhesive tape 64, whereby the double-sided adhesive tape 64 may peel off the base portion 60, or the base portion 60 may come off the flange 26.

### SUMMARY OF THE INVENTION

Accordingly, it is an object of the present invention to provide a weather strip for a motor vehicle, which is capable of being elongated or contracted upon the attachment to the motor vehicle to facilitate the attachment of the weather strip to the motor vehicle.

In accordance with the present invention, a weather strip for providing a seal between a closing member for closing an opening in a vehicle body and an opening portion of the vehicle body around the opening includes a base portion which is adapted to be attached to a flange provided in one member out of the closing member and the opening portion, and a seal portion integrally formed with the base portion for contacting the other member out of the closing member and the opening portion and sealing between the closing member and the opening portion. Longitudinal ends of the weather strip are connected to each other via a connecting section into a ring-shaped configuration. The base portion includes at least an outer side wall and a bottom wall, and has a generally L-shaped cross-section. A double-sided adhesive tape is bonded to the entire circumference of an interior face of the outer side wall except for a predetermined area inclusive of the connecting section, which ranges from one side of the connecting section to the other side thereof.

With this arrangement, since the weather strip is formed into a ring-shaped configuration by connecting the longitudinal ends thereof to each other via the connecting section, the closing member or the opening portion is completely sealed over the entire circumference thereof, and consequently, when the weather strip is attached to the vehicle body, the longitudinal ends thereof are prevented from separating from each other or being overlapped each other to facilitate the attachment of the weather strip.

The weather strip has a base portion adapted to be attached to a flange which is provided in one member out of the closing member and the opening portion, and a seal portion integrally formed with the base portion for contacting the other member out of the closing member and the opening portion and sealing between the closing member and the opening portion. Where the base portion is attached to the closing member or the opening portion of the vehicle body, the seal portion contacts the opening portion or the closing member when the closing member is closed, whereby a gap between the closing member and the opening portion can be sealed.

Since the base portion includes at least an outer side wall and a bottom wall, and has a generally L-shaped cross-section, the exterior face of the flange can be brought into close contact with the outer side wall where the thickness of the flange varies, and an end of the flange can be held and sealed with the bottom wall securely. By bringing the end of the flange into contact with the bottom wall, the outer side wall can be attached in position.

In addition, since the double-sided adhesive tape is bonded to the interior face of the outer side wall over approximately the entire circumference thereof, the base portion can be attached to the flange regardless of variations in the thickness of the flange, and the bonding area for the double-sided adhesive tape can be enlarged so that the base portion can be bonded securely.

Since the double-sided adhesive tape is not bonded to a predetermined area inclusive of the connecting section, which ranges from one side of the connecting section to the other side thereof, the predetermined area to which the double-sided adhesive tape is not bonded can be readily elongated and contracted when the weather strip is attached to the flange provided in the opening portion or the closing member. Where the entire length of the weather strip is elongated or contracted upon attachment, the predetermined area to which the double-sided adhesive tape is not bonded elongates or contracts to cancel variations in the dimensions of the weather strip.

It is preferable that the predetermined area to which the double-sided adhesive tape is not bonded ranges from 100 mm to 200 mm.

With this arrangement, the predetermined area to which the double-sided adhesive tape is not bonded ranges from 100 mm to 200 mm so that such an area can sufficiently cancel the elongation of the entire length of the weather strip upon the attachment to the flange provided in the opening portion or the closing member, and can prevent such an area from greatly separating from and coming off the flange, thereby ensuring good sealing properties.

It is preferable that the predetermined area to which the double-sided adhesive tape is not bonded has a projection which is continuously formed in a face facing the flange along an end of the outer side wall so as to extend in a longitudinal direction thereof.

With this arrangement, by virtue of the projection formed in the outer side wall, the predetermined area to which the double-sided adhesive tape is not bonded is prevented from separating from the flange and generating vibrations, whereby the attachment positions of the outer side wall as well as the tubular seal portion become stable to effect good sealing properties.

It is preferable that the bottom wall in a lower part of the weather strip, including the predetermined area to which the double-sided adhesive tape is not bonded, is covered with a scuff plate.

With this arrangement, the predetermined area to which the double-sided adhesive tape is not bonded can be pressed by the scuff pate against the end of the flange, whereby the weather strip can be prevented from coming off the flange to ensure good sealing properties.

It is preferable that the base portion is partly composed of a solid body with an L-shaped cross-section, and the seal portion is composed of a sponge body with a tubular configuration, and the solid body of the base portion is composed of a harder material than a material of a remaining part of the base portion. With this arrangement, by virtue of the L-shaped solid body, the outer side wall can be bonded to the side face of the flange irrespective of variations in the thickness of the flange, and consequently, the base portion can securely hold the tubular seal portion in position.

Since the seal portion is composed of a sponge body with a tubular configuration, the seal portion flexibly contact the opening portion or the closing member of a vehicle body when the closing member is closed, and where there occurs scattering in dimensions upon the assembling of vehicle parts, they can be sealed securely.

Since the solid part of the base portion is composed of a harder material than a material of a remaining part of the base portion, it can hold the end of the flange securely to maintain good sealing properties against the end of the flange.

It is preferable that the harder material is a hard rubber, a hard thermoplastic elastomer or a hard synthetic resin. With this arrangement, the weather strip can be integrally formed simultaneously by extrusion using an extruder to facilitate the production of the weather strip.

It is preferable that a caulking member is attached to an interior face of the bottom wall. With this arrangement, upon the attaching of the weather strip to the flange, the end of the flange is embedded in the caulking member so that when the flange is subjected to spot-welding, etc., the caulking member can prevent noises or rainwater from leaking from a gap formed between the body panels defining the flange. In addition, the caulking member can seal dust and noises intruding from the exterior of the vehicle body via gaps between the end of the flange and the bottom wall.

It is preferable that the closing member is a vehicle door, and the weather strip is an opening trim weather strip. With this arrangement, the base portion of the opening trim weather strip can seal a gap between the door opening portion and the vehicle door and prevent noises from intruding inwardly from the exterior of the vehicle body via gaps around the flange securely.

In accordance with present invention, the double-sided adhesive tape is bonded to the interior face of the outer side wall of the base portion so that the base portion can be attached to the flange irrespective of variations in the thickness of the flange, and the bonding area for the double-sided adhesive tape can be enlarged, whereby the base portion can be bonded securely.

Since no double-sided adhesive tape is bonded to the predetermined area inclusive of the connecting section of the weather strip, which ranges from one end of the connecting section to the other end thereof, such predetermined area can be elongated or contracted relative to the flange, and consequently, where the entire length of the weather strip elongates or contracts upon the attaching of the weather strip, such predetermined area can be elongated or contracted to cancel variations in the dimensions of the weather strip.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a perspective view of a motor vehicle of which a front door is opened;

FIG. 2 is a cross-sectional view of one example of a conventional opening trim weather strip which is attached to a door opening portion of a motor vehicle;

FIG. 3 is a partially cut away cross-sectional view of another example of a conventional opening trim weather strip which is attached to a door opening portion of a motor vehicle;

FIG. 4 is a partially cut away cross-sectional view of still another example of a conventional opening trim weather strip which is attached to a door opening portion of a motor vehicle;

FIG. 5 is a cross-sectional view of a first embodiment of an opening trim weather strip in accordance with the present invention, which is attached to a door opening portion of a motor vehicle, taken along the line of A-A of FIG. 7;

FIG. 6 is a cross-sectional view of a first embodiment of an opening trim weather strip in accordance with the present invention, which is attached to a door opening portion of a motor vehicle, taken along the line of B-B of FIG. 7;

FIG. 7 is a front view of an opening trim weather strip in accordance with the present invention; and

FIG. 8 is a cross-sectional view of a second embodiment of an opening trim weather strip in accordance with the present invention, which is attached to a door opening portion of a motor vehicle, taken along the line of B-B of FIG. 7.

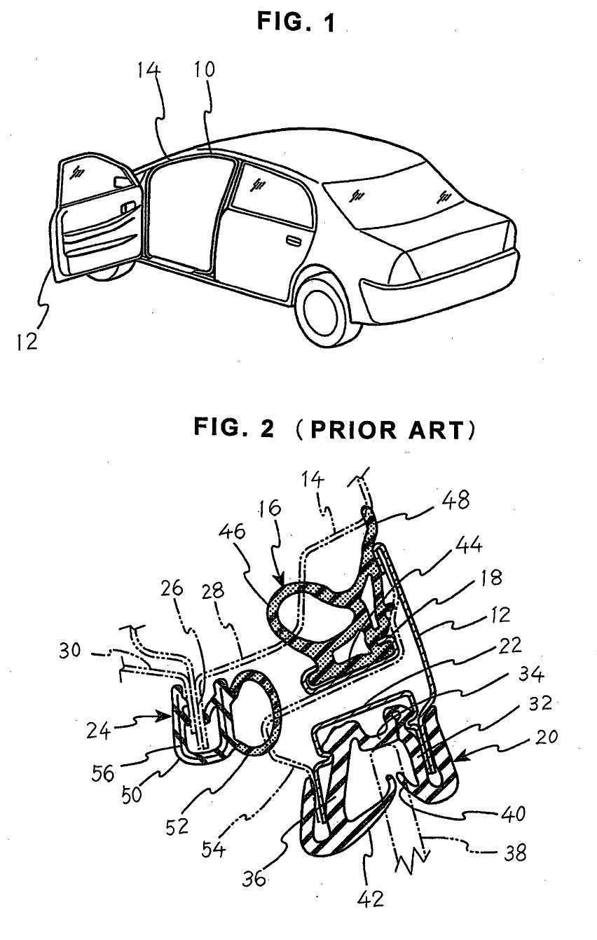

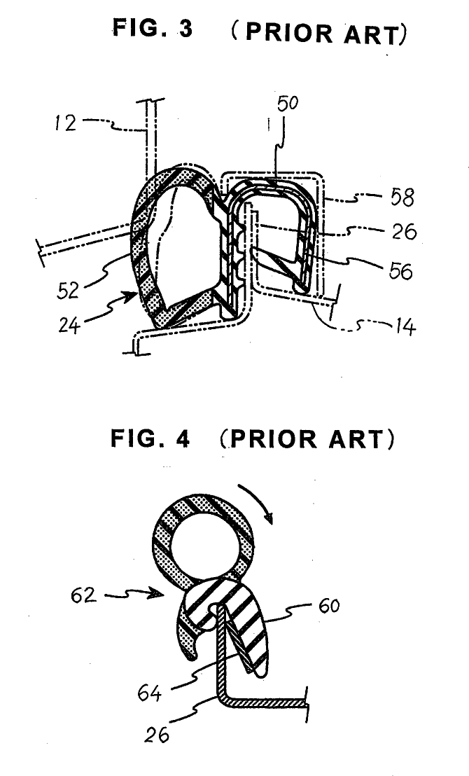

### DETAILED DESCRIPTION OF THE PREFERRED EMBODIMENTS

Hereinafter, embodiments of the present invention will be explained with reference to an opening trim weather strip for attachment to a vehicle door. The present invention is also applicable to other weather strips such as a sliding roof weather strip, a luggage weather strip, a rear door weather strip, etc., each being provided with a seal portion for forming a seal between an opening portion of a vehicle body and a closing member for closing the opening portion, as well as a base portion.

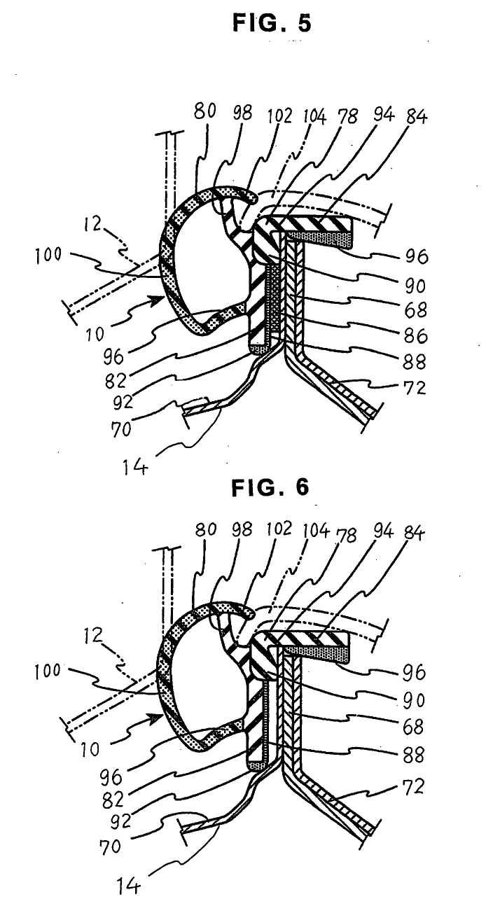

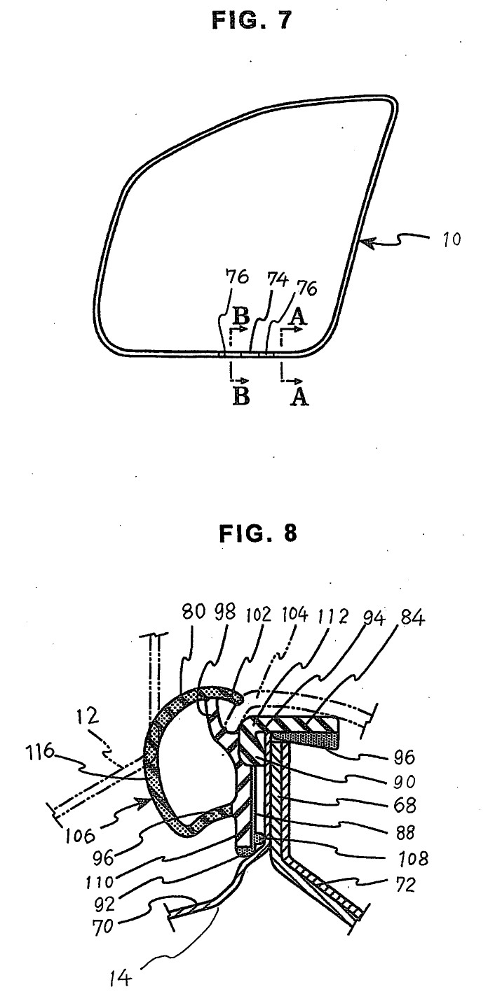

FIG. 5 is a sectional view of a first embodiment of an opening trim weather strip which is attached to a door opening portion of a motor vehicle, especially one part to which a double-sided adhesive tape is bonded, that is the part taken along the line A-A of FIG. 7.

FIG. 6 is a sectional view of the first embodiment of an opening trim weather strip which is attached to a door opening portion of a motor vehicle, especially another part to which a double-sided adhesive tape is not bonded, that is the part taken along the line B-B of FIG. 7.

FIG. 7 is a front view of an opening trim weather strip for attachment to a door opening portion of a vehicle body.

FIG. 8 is a sectional view of a second embodiment of an opening trim weather strip which is attached to a door opening portion of a motor vehicle, especially one part to which a double-sided adhesive tape is not bonded, that is the part taken along the line B-B of FIG. 7.

Hereinafter, a first embodiment of an opening trim weather strip will be explained with reference to FIG. 5 through FIG. 7. As shown in FIG.5, a door opening portion 14 of a vehicle body is formed around a door opening of the motor vehicle, which is closed by a vehicle door 12, and an opening trim weather strip 10 is attached to a flange 68 formed by welding ends of an outer body panel 70 and an inner body panel 72 together. The number of body panels to be welded for defining the flange 68 depends on the position in the door opening portion 14 of the vehicle body, and ranges from 2 to about 5 pieces. Therefore, the thickness of the flange 68 depends on the position in the vehicle body.

The opening trim weather strip 10 is formed into a linear configuration by extrusion, and is attached to the flange 68 along the door opening portion 14 into a ring-shaped configuration, as shown in FIG. 7. The opening trim weather strip 10 is gradually attached to the flange 68 from its one longitudinal end, and after attachment, its other longitudinal end is connected to its one longitudinal end with a connecting section 74 which is formed by molding.

Alternatively, longitudinal ends of the opening trim weather strip 10 may be bonded to each other into a ring-shaped configuration before attaching to the door opening portion 14. By bonding the longitudinal ends of the opening trim weather strip 10 into a ring-shaped configuration, the attachment of the opening trim weather strip 10 is facilitated.

Nonbonding sections 76 (later describing) to which no double-sided adhesive tape is bonded are provided on both sides of the connecting section 74.

The opening trim weather strip 10 has a trim portion (as a base portion) 78 for attachment to the flange 68, and a tubular seal portion 80 for providing a seal between the door 12 and the door opening portion 14.

The trim portion 78 includes an outer side wall 82 and a bottom wall 84, and has a generally L-shaped cross-section. To flexibly respond to the variations in the thickness of the flange 68, the bottom wall 84 of the trim portion 78 has a predetermined width. The outer side wall 82 and the bottom wall 84 of the trim portion 78 are integrally formed. No insert member composed of a metal sheet, a hard synthetic resin, etc., which is adapted to reinforce the holding force against the flange 68, is not embedded in the trim portion 78. Therefore, the opening trim weather strip 10 can be made lightweight.

The outer side wall 82 has a generally flat plate-shaped configuration, and a double-sided adhesive tape 86 is bonded to an interior face of the outer side wall 82. The opening trim weather strip 10 is bonded to the flange 68 with the double-sided adhesive tape 86.

Where the double-sided adhesive tape 86 is used, the bonding method is identical irrespective of variations in the thickness of the flange 68. The bonding force of the double-sided adhesive tape 86 against the flange 68 is the same in any case so that the attachment of the opening trim weather strip 10 is facilitated. In addition, where the double-sided adhesive tape 86 is bonded to the outer side wall 82, a large bonding area can be effected, whereby the trim portion 78 can be bonded securely.

Where a sponge layer 88 composed of a sponge material is provided on a face of the outer side wall 82, which faces the double-sided adhesive tape 86, and the double-sided adhesive tape 86 is bonded to the sponge layer 88, and where the double-sided adhesive tape 86 is composed of a sponge material and the thickness thereof is increased, the double-sided adhesive tape 86 can deform in conformity with irregularities such as concaves formed in the flange 68 due to spot-welding so as to be bonded to the flange 68 closely.

The outer side wall 82 may have a protrusion 90 which protrudes from the interior face thereof near the bottom wall 84. By bonding the double-sided adhesive tape 86 along the protrusion 90, the positioning of the double-sided adhesive tape 86 can be performed. Consequently, the double-sided adhesive tape 86 can be bonded to a predetermined position of the flange 68.

An end section 92 composed of a sponge material is formed integrally with an end of the outer side wall 82. When the outer side wall 82 is attached to the flange 68, the end section 92 contacts a bending part of the outer body panel 70 to seal a gap between the outer body panel 70 and the opening trim weather strip 10.

The bottom wall 84 has a generally flat plate-shaped configuration and is composed of a hard material integrally with the protrusion 90 formed in the interior face of the outer side wall 82.

When the end of the flange 68 contacts and pushes the bottom wall 84, a connecting area of the bottom wall 84 to the outer side wall 82, which is composed of the hard material, is restrained from deforming greatly, whereby the bonding position of the outer side wall 82 to the flange 68 can be determined, and consequently, the opening trim weather strip 10 can be securely attached to the flange 68.

A hard rubber or a hard synthetic resin can be used as the hard material, and a hard EPDM rubber with a JIS hardness of HA 90°˜95°, etc. can be used as the hard rubber, and a hard polyethylene, a hard polypropylene, etc. can be used as the hard synthetic resin. In addition, a hard thermoplastic olefin elastomer with a JIS hardness of HA 90°˜95° can be also used.

Where a hard EPDM rubber, hard polyethylene, hard polypropylene, etc. are used as the hard material, and a soft EPDM rubber, soft thermoplastic olefin elastomer, etc. are used to form remaining parts, the opening trim weather strip 10 can be simultaneously formed by extrusion, using an extruder.

The remaining parts of the trim portion 78 can be composed of a soft EPDM rubber and a soft thermoplastic olefin elastomer, each having a JIS hardness of HA 60°˜85° which is less than that of the materials of the bottom wall 84. In this case, the trim portion 78 can exhibit both strength enough to hold the flange 68 and flexibility enough to follow variations in the configuration of the flange 68.

A step section 94 is provided in an interior face of the bottom wall 84 near the outer side wall 82 for holding the end of the flange 68. The step section 94 may be formed in the bottom wall 84 into an L-shaped stepped configuration, or may be defined with a side surface of a later-describing caulking sponge 96 and the interior face of the bottom wall 84.

When the end of the flange 68 (an end of the outer body panel 70 in the present embodiment) contacts a bottom of the step section 94, and a side face of the end of the outer body panel 70 contacts a side face of the step section 94, the end of the outer body panel 70 is engaged with the trim portion 78. Consequently, the attachment position of the opening trim weather strip 10 to the flange 68 can be determined securely.

Where the step section 94 is defined by the hard rubber, the step section 94 exhibits a sufficient hardness so as to be prevented from greatly deforming when the end of the flange 68 contacts the step section 94.

The caulking sponge 96 is bonded to the interior face of the bottom wall 84. Other materials than the sponge material, which exhibits flexibility and can cover and seal the end of the flange 68, will do. The caulking sponge 96 is bonded to the bottom wall 84 from its interior end to the neighborhood of the step section 94, and is formed such that the end of the outer body panel 70, that is the longest projecting end of the body panel out of the body panels defining the flange 68, can contact the step section 94.

In the first embodiment shown in FIG. 5, the bottom wall 84 inclusive of the connecting area to the outer side wall 82 is entirely composed of the hard material. Alternatively, only the interior face of the bottom wall 84 may be composed of the hard material, whereas the remaining part of the bottom wall 84 may be composed of the same material as that of the outer side wall 82.

The tubular seal portion 80 is composed of a tubular sponge body with a generally elliptical cross-section and is formed on the exterior face of the outer side wall 82. A sponge rubber, sponge-shaped thermoplastic elastomer, etc. are used. When the vehicle door 12 is closed, the tubular seal portion 80 contacts a door frame, ex. of the vehicle door 12 to seal a gap between the vehicle door 12 and the door opening portion 14. In order to improve the appearance of the door frame, a garnish (not shown) may be attached thereto. In this case, the tubular seal portion 80 contacts the garnish. The tubular seal portion 80 can be formed continuously with the bottom wall 84 according to the position of a facing member.

The tubular seal portion 80 includes a first connection wall 96 projecting from the neighborhood of the end of the outer side wall 82, a second connection wall 98 projecting from the connecting area of the outer side wall 82 to the bottom wall 84, a seal wall 100 which is formed to connect an end of the first connection wall 96 to an end of the second connection wall 98 into an arc-shaped cross-section, and a cover lip 102 which extends from the end of the seal wall 100 towards the bottom wall 84.

The tubular seal portion 80 may be replaced with a lip-shaped seal portion which is provided in the exterior face of the outer side wall 82.

When the opening trim weather strip 10 of the first embodiment is attached to the flange 68, the trim portion 78 is first positioned obliquely to the flange 68, and the end of flange 68 is brought into contact with the bottom wall 84. In this case, as the trim portion 78 does not include any inner side wall, the flange 68 can be inserted in the trim portion 78 by tilting the flange 68 obliquely to the trim portion 78.

At this time, since the outer body panel 70 which is the outermost body panel defining the flange 68 is formed slightly longer than the remaining panels, the end of the outer body panel 70 contacts the step section 94 provided in the bottom wall 84.

Then, the trim portion 78 is turned and the double-sided adhesive tape 86 is pressed against the exterior face of the flange 68. And the tubular seal portion 80 is pressed with a roller to bond the double-sided adhesive tape 86 to the flange 68. At this time, the end of the outer body panel 70 can slide on the interior face of the bottom wall 84 so that, as the trim portion 78 is turned, the end of the outer body panel 70 moves along the interior face of the bottom wall 84 and contacts the side face of the caulking sponge 96, which partly defines the step section 94. As a result, the outer body panel 70 is held in position. At this time, the double-sided adhesive tape 86 can face the exterior face of the flange 68, and by pressing the double-sided adhesive tape 86 against the flange 68, the trim portion 78 can be bonded to the flange 68.

A scuff plate 104 is further provided to cover the bottom wall 84. An end of the scuff plate 104 contacts the second connection wall 98, and is covered with the cover lip 102 of the tubular seal portion 80 in order to improve the appearance of the neighborhood of the end of the scuff plate 104.

Next, the nonbonding sections 76 where the double-sided adhesive tape 86 is not bonded to the outer side wall 82 of the trim portion 78 will be explained with reference to FIG. 6. The nonbonding sections 76 are formed on both sides of the connecting section 74. It is preferable that the nonbonding sections 76 inclusive of the connecting section 74 range from 100 mm to about 200 mm. With this arrangement, when the opening trim weatherstrip 10 is attached to the flange 68 provided in the door opening portion 14, the resultant elongation of the entire length of the opening trim weather strip 10 can be cancelled sufficiently, and the opening trim weather strip 10 is prevented from greatly coming off the flange 68, whereby the favorable sealing properties can be ensured.

At this time, the length of the connecting section 74 can be determined to range from 5 mm to 50 mm. In order to attach the trim portion 78 to the flange 68, clips (not shown) may be attached to the connecting section 74 by insert-molding. In order to impart flexibility to the connecting section 74, and cancel the elongation and contraction of the opening trim weather strip 10, the connecting section 74 may be composed of a sponge material or a soft material.

The nonbonding sections 76 are provided so as to face a lower part of the door opening portion 14. Therefore, the connecting section 74 is not exposed so as to be preferable in appearance.

The nonbonding sections 76 have a cross-sectional shape similar to that shown in FIG. 5 except that the double-sided adhesive tape 86 is not bonded. An end of the scuff plate 104 provided to cover the bottom wall 84 can press the nonbonding sections 76 against the end of the flange 68 to prevent it from coming off the flange 68, thereby improving the appearance of the opening trim weather strip 68 and ensuring the sealing properties.

A second embodiment of an opening trim weather strip in accordance with the present invention will be explained with reference to FIG. 8. An opening trim weather strip 106 of the second embodiment is similar to the opening trim weather strip 10 of the first embodiment except that a projection 108 is provided along an end of an outer side wall 110 of a trim portion 112 in nonbonding sections 114 corresponding to the nonbonding sections 76 in FIG. 7. Hereinafter, differences between the first embodiment and the second embodiment will be mainly explained, and explanations of similar arrangements to the first embodiment will be omitted. In FIG. 8, parts similar to those in FIG. 6 are given the same reference numerals as in FIG. 6.

The projection 108 is provided in the nonbonding sections 114 along the end of the outer side wall 110 so as to face the flange 68. In the nonbonding sections 114, no double-sided adhesive tape is bonded so that a space is defined between the outer side wall 110 and the flange 68. Therefore, in the nonbonding sections 114, problems such as the peeling and resultant vibrating of the outer side wall 110 relative to the flange 68 do not occur, whereby the attachment position of the outer side wall 110 becomes stable to contact a predetermined position of the door opening portion 14 with good sealing properties. The projection 108 may be formed in other sections of the outer side wall 110 than the nonbonding sections 114. In this case, the double-sided adhesive tape can be bonded to the area ranging from the projection 108 to the protrusion 90. As a result, the bonding position of the double-sided adhesive tape can be clearly determined, whereby the double-sided adhesive tape can be protected.

Alternatively, the projection 108 may be formed only in the molded connecting section 74 (FIG. 7) by enlarging the connecting section 74.

In the first and second embodiments, the opening trim weather strip 10 or 106 is composed of the following materials. Namely, the tubular seal portion 80 of the opening trim weather strip 10 or 106 is composed of a sponge material of an EPDM rubber or a thermoplastic olefin elastomer, whereas the trim portion 74 or 112 is composed of a solid material or a finely foamed material of an EPDM rubber or a thermoplastic olefin elastomer except for the hard material parts thereof, which are composed of a solid material of an EPDM rubber or a thermoplastic olefin elastomer. Resultant opening trim weather strip 10 or 106 exhibits good weather resistance. These materials are all olefin-based materials so that they can be recycled after pulverized together.

Next, the method for producing the opening trim weather strip 10 or 106 will be explained.

The opening trim weather strip 10 or 106 is formed by extrusion. A solid rubber for the trim portion 74 or 112 and a sponge rubber for the tubular seal portion 80 can be integrally extruded with an extruder A synthetic rubber such as an EPDM rubber, etc. and a thermoplastic elastomer such as a polyolefin elastomer, etc. are used as the forming material of the opening trim weather strip 10 or 106. The sponge material is prepared by foaming the above-described EPOM rubber and the thermoplastic elastomer.

In case of the hard material, polyethylene resin, polypropylene resin, hard rubber, hard thermoplastic elastomer, etc. can be used.

In case of the synthetic rubber, after extruded, it is heated in a vulcanizing chamber with a hot air and high frequency wave for vulcanizing and foaming. In case of the thermoplastic elastomer, and the soft synthetic resin, it is heated during extrusion or after extruded for foaming, and cooled for solidifying. Then, it is cut to predetermined lengths, whereby an extruded part of the opening trim weather strip 10 or 106 is obtained.

The opening trim weather strip 10 or 106 thus extruded may be connected into a ring-shaped configuration, and after connection, it is attached to the flange 68 provided in the door opening portion 14 of the vehicle body.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A weather strip for a motor vehicle, which is capable of providing a seal between a closing member for closing an opening formed in a vehicle body and an opening portion of the vehicle body around the opening, comprising:
a base portion which is adapted to be attached to a flange provided in one of the closing member and the opening portion of the vehicle body; and
a seal portion integrally formed with said base portion for contacting the other one of the closing member and the opening portion, and sealing a gap between the closing member and the opening portion, wherein longitudinal ends of said weather strip are connected to each other via a connecting section into a ring-shaped configuration, said base portion has a generally L-shaped cross-section, and includes at least an outer side wall and a bottom wall, a double-sided adhesive tape is bonded to an approximately entire circumference of an interior face of said outer side wall except for a predetermined area inclusive of said connecting section, which ranges from one side of said connecting section to the other side thereof.

2. A weather strip for a motor vehicle as claimed in claim 1, wherein said predetermined area to which said double-sided adhesive tape is not bonded ranges from 100 mm to 200 mm.

3. A weather strip for a motor vehicle as claimed in claim 1, wherein said predetermined area to which said double-sided adhesive tape is not bonded has a projection which is continuously formed in a face facing said flange along an end of said outer side wall so as to extend in a longitudinal direction thereof.

4. A weather strip as claimed in claim 1, wherein said bottom wall in a lower part of said weather strip, including said predetermined area to which the double-sided adhesive tape is not bonded, is covered with a scuff plate.

5. A weather strip as claimed in claim 1, wherein said base portion is partly composed of a solid body with an L-shaped cross-section, and said seal portion is composed of a sponge body with a tubular configuration, and said solid body of said base portion is composed of a harder material than a material of a remaining part of said base portion.

6. A weather strip as claimed in claim 5, wherein said harder material is one of a hard rubber, a hard thermoplastic elastomer and a hard synthetic resin.

7. A weather strip as claimed in claim 1, wherein a caulking member is attached to an interior face of said bottom wall.

8. A weather strip as claimed in claim 1, wherein said closing member is a door, and said weather strip is an opening trim weather strip.
